(19) United States
(12) Patent Application Publication
(10) Pub. No.: US 2025/0194643 A1
(43) Pub. Date: Jun. 19, 2025

(54) MIMICKING HEALTH BENEFITS OF PHYSICAL EXERCISE OR VOLUNTARY COLD EXPOSURE IN ANIMALS

(71) Applicant: Société des Produits Nestlé S.A., vevey (CH)

(72) Inventors: Yuanlong PAN, Chesterfield, MO (US); Julie Kristine Spears, St. Louis, MO (US); Sandeep Bhatnagar, BALLWIN, MO (US); Hui XU, Chesterfield, MO (US)

(73) Assignee: Société des Produits Nestlé S.A., vevey (CH)

(21) Appl. No.: 18/969,214

(22) Filed: Dec. 4, 2024

Related U.S. Application Data
(60) Provisional application No. 63/609,766, filed on Dec. 13, 2023.

(51) Int. Cl. A23K 20/147; A23K 50/42; A23L 33/17

(52) U.S. Cl. CPC A23K 20/147; A23K 50/42; A23L 33/17

(57) ABSTRACT

A method of mimicking health benefits of physical exercise or voluntary cold exposure, e.g., cold plunge, in an animal can include administering to the animal a high protein diet including from about 150% to about 400% of a Recommended Daily Allowance (RDA) of protein for the animal on a daily basis. The high protein diet can be sufficient to increase a 12,13-diHOME blood level for an 18-24 hour period per day compared to a baseline blood level without the need for the physical exercise or voluntary cold exposure.

### CROSS REFERENCE TO RELATED APPLICATIONS

This application claims priority to U.S. Provisional application No. 63/609,766 filed Dec. 13, 2023, the disclosure of which is incorporated in its entirety herein by this reference.

### BACKGROUND

Physical exercise and other physical activity in animals, such as pets and humans, can improve the general health of the animal, including providing enhanced cardiovascular health, mental health, metabolic health, and life span/health span, and can also provide a reduced risk of many chronic diseases. For example, physical exercise, voluntary cold exposure, e.g., cold plunge, etc. can promote some of these health benefits via the production of certain lipokines. Some of these lipokines in the body may be generated in response to physical exercise and other physical activity. However, many animals, such as pets and/or humans, tend to have lower blood levels of certain lipokines compared more active animals. Increasing the blood levels of such compounds can increase mitochondrial biogenesis and fatty acid oxidation in skeletal muscle, and can also improve cardiac hemodynamics and mitochondrial respiration in skeletal muscle and cardiac muscle. As physical exercise or voluntary cold exposure, etc., have become more understood, the health concerns over animals that lead a more sedentary lifestyle have likewise become clearer. This can be a particular issue, for example, with animals that may not be able to exercise and/or may not be given the opportunity to exercise at no fault of their own. For example, a disabled person owning a companion animal may not be able to provide themselves or their pet a proper amount of exercise due to circumstance. Thus, it would be beneficial to provide a way for more sedentary animals to mimic, or in some cases even improve upon some of the health benefits of physical exercise or voluntary cold exposure.

### DETAILED DESCRIPTION

Lipokines, such as the oxylipin referred to as 12,13-dihydroxy-9Z-octadecenoic acid (or 12,13-diHOME), are bioactive compounds that have various signaling pathways in the bodies of animals, including humans, pets, and/or other mammals. 12,13-diHOME in particular seems to be closely associated with improved cardiac and/or metabolic health, e.g., providing a positive impact on obesity and/or metabolic disease. Increasing blood levels of 12,13-diHOME can ameliorate some concerns associated with a sedentary way of life.

12,13-diHOME is typically derived from adipose tissue depots and can stimulate the browning process of white adipose tissue. 12,13-diHOME also appears to promote lipolysis of fats and other lipids, which relates to their breakdown by hydrolysis to release fatty acids. Additionally, 12,13-diHOME in the blood also appears to promote the absorption or uptake of fatty acids. In addition, this particular lipokine can also promote fatty acid oxidation and mitochondrial biogenesis. With this in mind, 12,13-diHOME appears to have a relatively significant impact on various health issues, which have been more closely associated with physical activity, such as physical exercise, voluntary cold exposure, or the like. For reference, an example structure of 12,13-diHOME is shown below as Formula I, as follows:

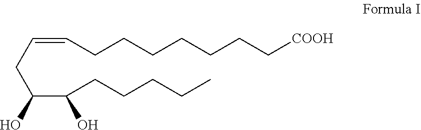 [SMILES: CCCCC[C@@H](O)[C@@H](O)C/C=C\CCCCCCCC(=O)O]

It has been recognized that rather than requiring physical exercise, voluntary cold exposure, or other similar physical activity that can increase the circulating blood level of 12,13-diHOME, the adoption of a high protein diet can provide an alternative approach to the increase of 12,13-diHOME in the blood. Furthermore, in some examples, with a daily consistent high protein diet, these higher blood levels may be present with fewer peaks and troughs that are more closely associated with the production of 12,13-diHOME after physical exercise and/or voluntary cold exposure, for example. As the glucose response in animals can be fairly rapid with a quick insulin spike followed by stabilization in a matter of hours (based on a healthy animal subject), the introduction of a high protein modified diet can typically lead to a fairly stable metabolic response within most animals in just a few days. Thus, with the high protein diet described herein, relatively stable 12,13-diHOME blood levels can likewise be achieved typically within a few days, within a week, or within a month, for example, particularly if the high protein diet is administered daily on a consistent basis. In other words, when the 12,13-diHOME blood levels might otherwise start to drop, e.g., within several hours after exercise and/or voluntary cold exposure, the high protein diet described herein can continue to sustain elevated blood levels of the 12,13-diHOME for more extended periods of time, e.g., from about 18 hours to about 24 hours per day, thus promoting enhanced metabolic health even without the need for physical exercise and/or voluntary cold exposure.

In accordance with the present disclosure, by administering a high protein diet of at least 150% of the Recommended Daily Allowance (RDA) of protein for the specific type of animal to which the high protein diet is administered, the blood levels of 12,13-diHOME can be increased compared to a baseline blood level measured prior to the high protein diet beginning. For example, administering a high protein diet to an animal of from about 150% to about 400% of the RDA of protein for that specific animal can increase the blood levels of 12,13-diHOME in the animal. To further increase the blood levels of 12,13-diHOME in an animal, the animal may be administered the high protein diet at about 175% to about 400% providing an even more significant increase in 12,13-diHOME blood levels, e.g., from about a two (2)-fold increase to about a six (6)-fold or even seven (7)-fold increase compared to a baseline blood level taken the day prior to starting the high protein diet, e.g., baseline levels measured at “Day 0.” Thus, the high protein diet described herein can deliver health benefits similar to those of physical exercise and/or voluntary cold exposure in animals, and in most instances, provide an even more sustained blood levels of 12,13-diHOME compared to physical activity.

In accordance with this, it is noted that when discussing examples related to the methods of mimicking health benefits of physical exercise or voluntary cold exposure, such discussions can be considered applicable to other related examples that are not specifically explicitly discussed in the context of that example. For example, when discussing “high protein diet” in the context of the methods herein, such disclosure can also be related to systems and/or compositions for achieving high protein diets in animals. Furthermore, terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

Thus, a method of mimicking health benefits of physical exercise or voluntary cold exposure in an animal can include administering to the animal a high protein diet including from about 150% to about 400% of a Recommended Daily Allowance (RDA) of protein for the animal on a daily basis, wherein the high protein diet is sufficient to increase a 12,13-diHOME blood level for an 18-24 hour period per day compared to a baseline blood level without the need for the physical exercise or voluntary cold exposure. In some examples, the high protein diet may include from about 150% to about 175% of the RDA of protein and the increased 12,13-diHOME blood level can be maintained over an 18-24 hour period compared to the baseline blood level. In other examples, the increased 12,13-diHOME blood level can be maintained over the 18-24 hour period without the animal engaging in physical exercise or voluntary cold exposure. In still other examples, the high protein diet includes from about 155% to about 400% of the RDA of protein and the increased 12,13-diHOME blood level can be maintained over the 18-24 hour period compared to the baseline blood level. The high protein diet may thus be adjusted upward or downward based on blood testing that can occur while the animal is on the high protein diet. In other examples, the 12,13-diHOME blood level can be higher over the 18-24 hour period compared to the baseline blood level without the animal engaging in physical exercise or voluntary cold exposure. In other examples, after about 3 days on the high protein diet, the 12,13-diHOME blood level may be increased compared to a baseline blood level for a full 24 hours per day. In still other examples, administering the high protein diet includes administering the high protein diet on a daily basis for a period of time of at least one (1) week, at least two (2) weeks, or at least one (1) month. In one example, administering can be on a regular basis and/or a long-term administration.

The type of animal that can benefit from the high protein diet can be of any type that has metabolic pathways that can generate and would benefit from enhancing the blood levels of 12,13-diHOME. For example, the animal may be a mammal, such as a pet that may experience limited to no physical activity, which is defined herein to include pets that do not engage in more than one day per week on average in exercise. Examples include a companion animal, an indoor pet, a pet with a disability, etc., including a dog, rodents, birds, etc. The animal may likewise be a human that leads a more sedentary lifestyle, which may be for any of a number of reasons, e.g., lifestyle choice, disability, etc.

Without limitation, using a dog for illustration, the RDA of protein (recommended for adult dog food) is currently 18 wt %, and the RDA for protein is achieved for the dog when the dog is fed a diet containing at least 18 wt % protein at 100% of its maintenance energy requirement (MER) per day. In accordance with the present disclosure, by increasing the protein content from 18 wt % to from about 25 wt % to about 75 wt % (based on a calculated 100% MER for that particular dog), the 12,13-diHOME blood levels can be increased over the baseline blood levels. In other examples, to increase blood levels of 12,13-diHOME in the dog by about 2-fold or more, the high protein diet may include administering a dog food on a daily basis containing from about 31.5 wt % to about 75 wt % protein calculated based on the 100% of the maintenance energy requirement for the dog (compared to the baseline blood level).

There may be instances where a dog (or other animal) is fed less than or more than its 100% maintenance energy requirement (MER). For example, the dog may be administered from about 50% to about 95% of its MER when receiving a lower calorie diet. In such instances, the dog food could be formulated to include an equivalent of about 25 wt % to about 75 wt % protein (for increasing blood levels of 12,13-diHOME) as calculated based on its 100% MER, even though the total calories being fed to the dog would be less than its daily MER. To illustrate by way of example, if a dog is fed 60% of its daily MER, using 100% MER as a basis to calculate how much protein content should be present in the dog food, the equivalent of 25 wt % protein (at 100% MER) in the dog food would be about 41.6 wt % protein, meaning that at least 41.6 wt % protein should be present in the dog food if the dog is being fed 60% of its daily MER. As the upper end of the range in this example is 75 wt % (based on its full MER), the protein content would exceed 100 wt %, and thus at a 60% MER diet, the protein content in the food would cap out 100 wt % protein. In other words, if feeding a dog 60% of its MER, the range of protein content in the dog food would range from about 41.6 wt % to 100 wt %. Similar calculations can be carried out when feeding the dog less than its 100% MER daily, e.g., 50% MER, 75% MER, 90% MER, etc.

In one embodiment, to increase blood levels of 12,13-diHOME in the dog by about 2-fold or more, the high protein diet may include administering a dog food on a daily basis containing from about 52.5 wt % to 100 wt % protein calculated based on the 100% of the maintenance energy requirement for the dog (compared to the baseline blood level).

To determine the baseline blood level so that the increase in blood levels may be determined, blood analysis of a dog that has not exercised that day and has been fed 100% of its daily MER of dog food containing at least 18 wt % protein, which is the percentage representing the RDA of protein for adult dogs. The increased blood levels can be obtained at about 24 hours after the dog receives its daily meal (or 24 hours after its first daily meal if the dog is fed twice per day), just prior to the meal offered the next day. To obtain more consistent levels of enhanced levels 12,13-diHOME, it may take a few days, a week, two weeks, or a month of the daily high protein diet before the benefits are fully realized, depending on the animal. However, similar to how the baseline blood level is measured, the blood level may be measured by sampling blood 24 hours after the dog receives its daily meal, which shows not only increased levels of the 12,13-diHOME in the blood, but also shows that the blood levels may be more stable than that which occurs with physical exercise and/or voluntary cold exposure.

Notably, these animal food percentage values work well with a variety of pets, and particularly pets that are not offered much opportunity to exercise, e.g. companion animals, because these animals are often given the same food on a daily basis, either once or twice per day. Thus, an individual animal will receive its RDA of protein simply by being administered or fed its daily maintenance energy requirement (MER), or 100% of its daily MER.

With humans, on the other hand, as they eat a much larger variety of food, the RDA of protein cannot be as easily determined based on the protein content in their food (based on 100% MER), as many foods that humans consume have very different protein contents. Thus, the expression of the RDA of protein in humans is more appropriately provided in terms of grams (of protein) per kg (of body weight). For purposes of the present disclosure and to align with the RDA of protein established by the Food and Drug Administration (FDA) of the United States as of the date of the filing of the present disclosure with the USPTO, the RDA for adult humans is established herein at 0.8 g/kg body weight (BW). It is notable that dogs are known to be one of the best animals when it comes to modeling biological processes and medical treatment in humans, as they are physiologically similar to humans, have roughly the same number of genes as humans, and their genome has been sequenced.

Thus, in accordance with this established RDA of protein in humans, administering the high protein diet can include administering from about 1.0 g/kg BW to about 4 g/kg BW of protein on a daily basis, which may result in increasing the 12,13-diHOME blood level compared to the baseline blood level of the human subject. To increase the 12,13-diHOME blood level by at least about 2-fold, the human subject can be administered from about 1.4 g/kg BW of the protein RDA on a daily basis, for example. To measure the increase in blood levels of 12,13-diHOME in humans, blood sample analysis can be carried out at Day 0 to get a baseline blood level, e.g., the day before beginning the high protein diet, and then once after the high protein diet, blood sample analysis can be carried to determine any change in blood levels of the 12,13-diHOME.

The food compositions disclosed herein can be any food formulated for consumption by an animal. In one embodiment, the food compositions can be pet food compositions. In one aspect, the pet food compositions can be formulated for a canine. In an embodiment, the pet food composition provides complete nutrition as defined by the Association of American Feed Control Officials (AAFCO) and which depends on the type of animal for which the composition is intended (e.g., a dog).

In addition to the above, in some embodiments, the food compositions can comprise protein in amounts from about 30%, 35%, 40%, 45%, 50%, 55%, 60%, or even 65% to about 35%, 40%, 45%, 50%, 55%, 60%, 65%, 70%, 75%, 80%, 85%, or even 90% by weight, including various subranges within these amounts. In one aspect, the protein can be from about 30% to about 60% of the food composition by weight.

The food composition can comprise meat, such as emulsified meat. Examples of suitable meat include poultry, beef, pork, lamb and fish, especially those types of meats suitable for pets. The meat can include any additional parts of an animal including offal. Some or all of the meat can be provided as one or more meat meals, namely meat that has been dried and ground to form substantially uniform-sized particles and as defined by AAFCO. Additionally or alternatively, plant protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

In one embodiment, the food compositions can comprise fat in amounts from about 5%, 10%, 15%, 20%, 25%, 30%, 35%, 40%, 45%, or even 50% to about 15%, 20%, 25%, 30%, 35%, 40%, 45%, 50%, 55%, or even 60%, including various subranges within these amounts by weight. In one aspect, the fat comprises from about 10% to about 40% of the food composition by weight.

The food compositions disclosed herein can comprise one or more of a vegetable oil, a flavorant, a colorant or water. Non-limiting examples of suitable vegetable oils include soybean oil, corn oil, cottonseed oil, sunflower oil, canola oil, peanut oil, safflower oil and the like. In some embodiments, the lipids in the composition can include medium chain triglycerides and one or more of any vegetable oil, any fish oil, the lipid from any meat, and any omega-3 fatty acids.

Non-limiting examples of suitable flavorants include yeast, tallow, rendered animal meals (e.g., poultry, beef, lamb, pork), flavor extracts or blends (e.g., grilled beef), animal digests, and the like. Non-limiting examples of suitable colorants include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The food compositions disclosed herein can optionally include additional ingredients, such as starches, humectants, oral care ingredients, preservatives, amino acids, fibers, prebiotics, sugars, animal oils, aromas, other oils additionally or alternatively to vegetable oil, salts, vitamins, minerals, probiotic microorganisms, bioactive molecules or combinations thereof.

In one embodiment, the carbohydrate comprises from about 1% to about 70% of the food composition by weight. In another embodiment, the carbohydrate comprises from about 20% to about 60% of the food compositions by weight. In other aspects, the carbohydrate can be present in amounts from about 1%, 5%, 10%, 20%, 30%, 40%, or even 50%, to about 5%, 10%, 20%, 30%, 40%, 50%, 60%, or even 70% by weight.

Non-limiting examples of suitable starches include a grain such as corn, rice, wheat, barley, oats, potatoes, peas, beans, cassava, and the like, and mixtures of these grains, and can be included at least partially in any flour. Non-limiting examples of suitable humectants include salt, sugars, propylene glycol and polyhydric glycols such as glycerin and sorbitol, and the like. Non-limiting examples of suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Non-limiting examples of suitable preservatives include potassium sorbate, sorbic acid, sodium methyl para-hydroxybenzoate, calcium propionate, propionic acid, and combinations thereof.

Specific amounts for each additional ingredient in the food compositions disclosed herein will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

Yet another aspect of the present disclosure is a method of making a pet food, the method comprising combining any of the comestible ingredients described above, mixing the ingredients, extruding the mixture, optionally, drying the extrudate, and optionally cutting or breaking the extrudate into individual kibbles.

In one embodiment, the composition can comprise arginine, eicosapentaenoic acid, docosahexaenoic acid, vitamin E, and B vitamins. Such B vitamins can include any combination of vitamin B1 (thiamine), vitamin B2 (riboflavin), vitamin B3 (niacin, nicotinic acid, nicotinamide), vitamin B5 (pantothenic acid), vitamin B6 (pyridoxine, pyridoxal, pyridoxamine), vitamin B7 (biotin), vitamin B8 (myo-inositol), vitamin B9 (folic acid) vitamin B12 (cobalamin compounds including methylcobalamin, hydroxocobalamin, and cyanocobalamin).

Generally, the composition can be administered sufficiently such that the 12,13-diHOME is increased to a desired level. In one aspect, the administration can be on a regular basis. In another aspect, the administration can be a long-term administration. Administration of the composition can include any manner of delivery. In one embodiment, the composition can be administered in conjunction with a food composition. In another embodiment, the composition is a pet food. In still another embodiment, the composition can be a sachet or supplement administered in conjunction with a food. In yet another embodiment, the composition can be a sachet or supplement administered separately from other food compositions.

Additionally, the present compositions can comprise omega-3 fatty acids. Non-limiting examples of suitable omega-3 fatty acids include eicosapentaenoic acid (EPA), docosahexaenoic acid (DHA), alpha-linolenic acid (ALA) and mixtures thereof. In one embodiment, the omega-3 fatty acids can range from about 0.2%, 0.5%, 1%, 2%, or even 3% to about 1%, 2%, 3%, 4%, or even 5% of the composition by weight. In some embodiments, the omega-3 fatty acids are present in the food composition in an amount from about 0.6% to about 5% by weight. In some embodiments, the omega-3 fatty acids are present in the food composition in an amount from about 0.3% to about 2% by weight.

In addition to the fats and fatty acids discussed herein, the present compositions can comprise omega-6 fatty acids. Non-limiting examples of suitable omega-6 fatty acids include linoleic acid, gamma-linolenic acid (GLA), arachidonic acid (AA, ARA), eicosadienoic acid, docosadienoic acid, and mixtures thereof. In one embodiment, the omega-6 fatty acids can range from about 0.2%, 0.5%, 1%, 2%, or even 3% to about 1%, 2%, 3%, 4%, or even 5% of the composition by weight. In some embodiments, the omega-6 fatty acids are present in the food composition in an amount from about 1% to about 5% by weight. In some embodiments, the omega-6 fatty acids are present in the food composition in an amount from about 1% to about 2% by weight.

According to the presently described methods, administration, including administration as part of a dietary regimen, can span a period ranging from parturition through the adult life of the animal. In certain embodiments, the animal can be a young or growing animal. In other embodiments, administration can begin, for example, on a regular or extended regular basis, when the animal has reached more than about 10%, 20%, 30%, 40%, or 50% of its projected or anticipated lifespan. In some embodiments, the animal can have attained 40, 45, or 50% of its anticipated lifespan. In yet other embodiments, the animal can be older having reached 60, 66, 70, 75, or 80% of its likely lifespan. A determination of lifespan may be based on actuarial tables, calculations, estimates, or the like, and may consider past, present, and future influences or factors that are known to positively or negatively affect lifespan. Consideration of species, gender, size, genetic factors, environmental factors and stressors, present and past health status, past and present nutritional status, stressors, and the like may also influence or be taken into consideration when determining lifespan.

### Example Embodiments

In accordance with the disclosure herein, the following examples are illustrative of several embodiments of the present technology.

1. A method of mimicking health benefits of physical exercise or voluntary cold exposure in an animal, comprising administering to the animal a high protein diet including from about 150% to about 400% of a Recommended Daily Allowance (RDA) of protein for the animal on a daily basis, wherein the high protein diet is sufficient to increase a 12,13-diHOME blood level for an 18-24 hours period per day compared to a baseline blood level without the need for the physical exercise or voluntary cold exposure.

2. The method of claim 1, wherein the high protein diet includes from about 175% to about 400% of the RDA of protein and the 12,13-diHOME blood level is increased by at least 2-fold over the 18-24 hour period compared to the baseline blood level.

3. The method of any of claims 1-2, wherein the 12,13-diHOME blood level is higher over the 18-24 hour period compared to the baseline blood level without the animal engaging in physical exercise or voluntary cold exposure.

4. The method of any of claims 1-3, wherein the animal is a pet.

5. The method of any of claims 1-4, wherein the pet is a dog.

6. The method of claim 5, wherein the RDA of protein for the dog is 18 wt % based on 100% of a maintenance energy requirement for the dog, and wherein the high protein diet includes administering a dog food on a daily basis containing from about 25 wt % to about 75 wt % protein calculated based on the 100% of the maintenance energy requirement for the dog.

7. The method of any of claims 5-6, further comprising administering from about 50% to about 95% of the maintenance energy requirement for the dog, wherein the dog food still includes an equivalent of the about 25 wt % to about 75 wt % protein calculated based on the 100% of the maintenance energy requirement.

8. The method of claim 1, wherein the animal is a human.

9. The method of claim 8, wherein administering the high protein diet includes administering from about 1.0 g/kg to about 4 g/kg of the protein daily, and wherein the administering increases the 12,13-diHOME blood level compared to the baseline blood level.

10. The method of any of claims 8-9, wherein the human is identified as leading a sedentary lifestyle of less than 30 minutes of exercise per week.

11. The method of any of claims 8-10, wherein the human has a disability that diminishes the ability of regular physical exercise.

12. The method of any preceding claim, wherein the animal is a companion animal that does not experience physical exercise or voluntary cold exposure on more than about one day per week on average.

13. The method of any preceding claim, wherein after about 3 days on the high protein diet, the 12,13-diHOME blood level is increased compared to a baseline blood level for a full 24 hours per day.

14. The method of any preceding claim, wherein administering to the animal the high protein diet includes administering the high protein diet on daily basis for a period of time at least 1 week.

### Definitions

The terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

The term “animal” means any animal that has a need for the health benefits disclosed herein, including mammals, such as human, avian, bovine, canine, equine, feline, hircine, lupine, murine, ovine, or porcine animals.

The term “companion animal” means a dog or a cat. As used herein, the term “cat” and “feline” can be used interchangeably. In one embodiment, the companion animal can be a dog.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced pet food and animal food compositions are widely known and widely used in the art, e.g., complete and balanced food compositions formulated according to standards established by the Association of American Feed Control Officials (AAFCO) as of Jan. 1, 2023.

As used herein, “comprising” or “including” language or other open-ended language can be substituted with “consisting essentially of” and “consisting of” as if such transition phrase is expressly included in such embodiments.

The term “long-term administration” means periods of repeated administration or consumption in excess of one month. Periods of longer than two, three, or four months can be used for certain embodiments. Also, more extended periods can be used that include longer than 5, 6, 7, 8, 9, or 10 months. Periods in excess of 11 months or 1 year can also be used. Longer term use extending over 1, 2, 3, or more years are included in the invention. For certain aging animals, the animal will continue consuming on a regular basis for the remainder of its life. This can also be referred to as consumption for “extended” periods.

The term “regular basis” means at least monthly dosing with the compositions or consumption of the compositions, and in one aspect, means at least weekly dosing. More frequent dosing or consumption, such as twice or three times weekly, can be performed in certain embodiments. Still, in other embodiments, regimens can be used that comprise at least once daily consumption.

The term “about” refers to values similar to specifically enumerated numbers with some flexibility that would not substantially alter the function of the benefit achieved by the value(s) provided. For example, the term “about” can refer to the recited number plus or minus 10%, plus or minus 5%, plus or minus 3%, or plus or minus 1%. To illustrate, the term “about” when interpreted as being plus or minus 5% of a numeric range, such as “from about 1 cm to about 2 cm,” would be interpreted as including a range from 9.5 mm to 2.1 cm, from 1.05 cm to 1.9 cm, from 9.5 mm to 1.9 cm, or 1.05 cm to 2.1 cm. Similar calculations for any of the other individual numerical values or individual parameters of numerical ranges set forth herein can be modified similarly such that the “about” modifier fully supports subranges including +/−3% or +/−1% of the numerical value provided.

All percentages expressed herein are by weight (wt %) of the composition on a dry matter basis unless specifically stated otherwise. The skilled artisan will appreciate that the term “dry matter basis” means that an ingredient's concentration or percentage in a composition is measured or determined after any free moisture in the composition has been removed. When reference is made to the pH, values correspond to pH measured at 25° C. with standard equipment. An “amount” can be the total amount of the referenced component per serving of the composition or per distinct unit of the composition and/or can be the weight percentage of the referenced component by dry weight. Moreover, an “amount” includes zero; for example, the recitation of an amount of a compound does not necessarily mean that the compound is present, unless followed by a range that excludes zero.

As used herein, ranges are in shorthand so as to avoid having to list and describe each and every value within the range. Any appropriate value within the range can be selected, where appropriate, as the upper value, lower value, or the terminus of the range, and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting one numerical value. Furthermore, such an interpretation should apply regardless of the breadth of the range or the characteristics being described.

The term “example(s)” or “embodiment(s),” such as when followed by a listing of terms or when giving a specific illustration including details of a single or multiple parameters is merely illustrative and should not be deemed to be exclusive or comprehensive.

The methods and any compositions disclosed herein are not limited to particular methodology, protocols, reagents, etc., described herein because, as the skilled artisan will appreciate, they may vary. Further, the terminology used herein is for the purpose of describing particular embodiments only, and is not intended to and does not limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, certain compositions, methods, articles of manufacture, or other means or materials are described herein.

As used herein, a plurality of elements, compositional components, and/or materials may be presented in a common list for convenience. However, these lists should be construed as though individual members of the list are individually identified as separate and unique members. Thus, no individual member of such list should be construed as a de facto equivalent of any other member of the same list solely based on presentation in a common group without indications to the contrary.

### EXAMPLES

Features of the present disclosure are illustrated by the following examples, although it will be understood that these examples are included merely for purposes of illustration and are not intended to limit the scope of the invention.

### Example 1-One (1) Year Enhanced Protein Dog Study with Increased Caloric Intake

Thirty (30) adult dogs were randomized into two groups of 15 dogs based on baseline maintenance energy requirements (MERs), body weight, body condition score, and percent body fat, providing a control group of 15 dogs and a high protein group of 15 dogs. Data was collected based on several criteria, including baseline maintenance energy requirements (MERs), which takes into account the dogs age, whether the dog has been neutered, weight, gender, activity level, body condition score, percent (%) body fat, etc. The baseline MERs can be established using criteria from the MER Calculator for Dogs from the Purina™ Institute, which provides the estimated daily caloric needs of the dog. In determining the MERs for the individual dogs, the body condition score may be established using the Body Condition System from the Purina institute, which is based on a scale of 1-9 (ranging from a score of 1 where the dog exhibits ribs, lumbar vertebrae, pelvic bones and all bony prominences evident from a distance; no discernible body fat; and obvious loss of muscle mass—to a score of 9 where the dog exhibits massive fat deposits over the thorax, spine, and base of tail; waist and abdominal tuck absent; fat deposits on the neck and limbs; and obvious abdominal distention).

Once the daily caloric needs for each dog were established based on the MERS, all 30 dogs were fed 100% of their baseline MERs (or 100% of their daily caloric needs) using the control food containing 28.26 wt % protein content (DM), which is about 157% of the protein RDA for adult dogs to establish a baseline for all of the dogs (Taken at Day 0, or the day prior to the overfeeding regimen). Notably, starting on Day 0 and throughout the duration of the study, the dogs were taken off of their exercise regimen. After establishing the baseline for each dog, the individual dogs in the control group were fed a control diet set at 125% of their individual MERs on a daily basis for one (1) year. The dogs in the control diet group were fed the control diet with protein level equivalent to 196% of the RDA of protein for dogs at 125% of MER feeding.

Simultaneously, the individual dogs in the high protein group were fed a high protein diet set at 125% of their individual MERs on a daily basis for one (1) year. The high protein diet included an even higher protein content in the dog food, which was established at 57.72 wt % protein at 100% MER feeding. The dogs in the high protein group were fed the high protein diet with protein level equivalent to 401% of the RDA of protein for dogs at 125% MER feeding. Thus, in this study, not only did the dogs receive an increased protein content, but they also received more calories than established by the baseline MERs, e.g., 125% of MERs.

In short, the dogs were fed 100% of their maintenance energy requirements (MERs) at baseline with the control diet (Table 1), and then 125% of their baseline MERs with either the Control Diet or the High Protein Diet for twelve (12) months (Table 2), Table 2 summarizes the percentage of protein offered in the dog food of both groups, along with a calculated percentage of dietary protein relative to the Recommended Daily Allowance (RDA) for dogs,

TABLE 1
Weight Percent (wt %) Protein and Percent (%)
RDA of Protein at baseline (at 100% MER)

| Diets | wt % Protein (DM*) | % RDA Protein** |
|---|---|---|
| Control Diet | 28.26 | 157 |
| Control Diet | 28.26 | 157 |

*Dry Matter
**Percentage based on RDA of 18 wt % Protein at 100% MER Feeding

TABLE 2
Weight Percent (wt %) Protein and Percent
(%) RDA of Protein at 125% of MER

| Diets | wt % Protein (DM*) | % RDA Protein** |
|---|---|---|
| Control Diet | 28.26 | 196 |
| High Protein Diet | 57.72 | 401 |

*Dry Matter
**Percentage based on RDA of 18 wt % Protein at 125% MER Feeding

### Example 2—Metabolomic Data of Control Diet vs. High Protein Diet

Using the two groups of dogs as described in Example 1, blood samples were collected to establish a baseline for each dog for both groups, and then blood samples were again taken at twelve (12) months, i.e. one year later or “Year 1.” Blood samples were collected 24 hours after the feeding of the diets. The blood samples were subjected to metabolomic analyses to measure 12,13-diHOME blood levels, and the data is provided in Table 3, as follows:

TABLE 3
12,13-diHOME Blood Levels†

| | Control Diet | | High Protein Diet | |
|---|---|---|---|---|
| | (Area under curve) | | (Area under curve) | |
| | Baseline (Day 0) | Year 1 | Baseline (Day 0) | Year 1 |
| 12,13-diHOME | 0.9034 | 0.939 | 0.7994 | 5.144 |

†Blood levels measured about 24 hours after meal (just prior to the next daily meal)

As can be seen in Table 3, the metabolomic data collected showed that with a daily dietary protein content set at 196% RDA (without physical exercise or voluntary cold exposure), there was a slight increase in 12,13-diHOME at Year 1 compared to the 12,13-diHOME blood levels at the baseline (prior to increasing the protein intake in the Control Diet group). Thus, at 196% RDA of protein, the 12,13-diHOME blood levels were at least maintained on average across the population of dogs of the Control Group, e.g., 0.939/0.9034=1.039. On the other hand, the dogs in the high protein group that were provided with dog food at 401% RDA of protein experienced a significant increase in the average blood levels of 12,13-diHOME, even without any physical exercise or voluntary cold exposure. More specifically, the dogs in the high protein group that were offered the high protein diet exhibited a 6.44 increase in 12,13-diHOME compared to their baseline levels, e.g., 5.144/0.7994=6.44-fold increase. This data indicates that dietary protein at 196% of RDA can slightly increase 12,13-diHOME, and dietary protein at 401% of RDA mimics the effect of physical exercise on 12,13-diHOME

### Example 3-Six (6) Month Enhanced Protein Dog Study with Decreased Caloric Intake

Thirty (30) adult dogs were randomized into two groups of 15 dogs based on baseline maintenance energy requirements (MERs), gender, body weight, body condition score, and percent body fat, providing a control group of 15 dogs and a high protein group of 15 dogs. Data was collected based on several criteria, including baseline maintenance energy requirements (MERs), which takes into account the dogs age, whether the dog has been neutered, weight, gender, activity level, body condition score, percent (%) body fat, etc. The baseline MERs can be established using criteria from the MER Calculator for Dogs from the Purina™ Institute, which provides the estimated daily caloric needs of the dog. In determining the MERs for the individual dogs, the body condition score may be established using the Body Condition System from the Purina institute, which is based on a scale of 1-9 (ranging from a score of 1 where the dog exhibits ribs, lumbar vertebrae, pelvic bones and all bony prominences evident from a distance; no discernible body fat; and obvious loss of muscle mass—to a score of 9 where the dog exhibits massive fat deposits over the thorax, spine, and base of tail; waist and abdominal tuck absent; fat deposits on the neck and limbs; and obvious abdominal distention).

Once the daily caloric needs for each dog were established based on the MERS, all 30 dogs were fed 100% of their baseline MERs (or 100% of their daily caloric needs) using the control food containing 28.77 wt % protein to establish a blood baseline for all of the dogs. Notably, starting on Day 0 and throughout the duration of the study, the dogs were taken off of their exercise regimen. After establishing the baseline for each dog, the individual dogs in the control group were fed a control diet set at 75% of their individual MERs on a daily basis for four (4) months followed by 60% of their individual baseline MERs for two (2) additional months. The dog food of the control diet had a protein content of 28.77 wt %, so at 60% MER, the dog food still provided 18 wt % daily protein (the recommended daily allowance RDA); i.e., the percent of dietary protein offered to the control dogs at 60% of their MERs was calculated to be about 100% of the RDA for protein.

Simultaneously, the individual dogs in the high protein group were also fed a control diet set at 75% of their individual baseline MERs on a daily basis for four (4) months followed by 60% of their individual baseline MERs for two (2) additional months. However, the dog food of the high protein diet had a protein content of 52.94 wt %, so at 60% of the amount of dog food offered, and based on a RDA of 18 wt % protein content with 100% MER feeding, the percent of dietary protein offered to the dogs at 60% of their MERs was calculated to be about 177% of the RDA for protein.

Tables 4 and 5 summarize the percentage of protein offered in the dog food of both groups, along with a calculated percentage of dietary protein relative to the Recommended Daily Allowance (RDA) for dogs, as follows:

TABLE 4
Weight Percent (wt %) Protein and Percent (%)
RDA of Protein at baseline (at 100% MER)

| Diets | wt % Protein (DM*) | % RDA Protein** |
|---|---|---|
| Control Diet | 28.77 | 160 |
| Control Diet | 28.77 | 160 |

*Dry Matter
**Percentage based on RDA of 18 wt % Protein at 100% MER Feeding

TABLE 5
Weight Percent (wt %) Protein and Percent
(%) RDA of Protein at 60% MER

| | | % RDA Protein |
|---|---|---|
| Diets | wt % Protein (DM*) | (60% MER Feeding)** |
| Control Diet | 28.77 | 100 |
| High Protein Diet | 52.94 | 177 |

*Dry Matter
**Percentage based on RDA of 18 wt % Protein at 60% MER Feeding

### Example 4-Metabolomic Data of Control Diet Vs. High Protein Diet

Using the two groups of dogs as described in Example 3, blood samples were collected to establish a baseline blood level for each dog for both groups, and then blood samples were again taken after six (6) months at Month 6. Blood samples were collected 24 hours after the feeding of the diets. Again, the dogs were fed 100% of their maintenance energy requirements (MERs) at baseline with the control diet, and then 75% (for 4 months) and 60% (for the final 2 months) of their baseline MERs with either the Control Diet or the High Protein Diet for a total of 6 months, i.e. “Month 6.” The blood samples were subjected to metabolomic analyses to measure 12,13-diHOME blood levels, and the data is provided in Table 6, as follows:

TABLE 6
12,13-diHOME Blood Levels†

| | Control Diet | | High Protein Diet | |
|---|---|---|---|---|
| | (Area under curve) | | (Area under curve ) | |
| | Baseline | | Baseline | |
| | (Day 0) | Month 6 | (Day 0) | Month 6 |
| 12,13-diHOME | 0.9969 | 0.3953 | 1.1951 | 2.3756 |

†Blood levels measured about 24 hours after meal (prior to next daily meal)

As can be seen in Table 6, the metabolomic data collected showed that with a daily dietary protein content set at 100% RDA (without significant physical exercise), there was a significant decrease in 12,13 diHOME (0.3953) at Month 6 compared to the baseline 12,13-diHOME blood levels (0.9969) when the dogs were fed 160% of the RDA of dietary proteins. Thus, without physical exercise (or other similar activity, such as voluntary cold exposure/cold plunge), providing the dogs with 100% RDA of protein resulted in a 60% loss in 12,13-diHOME blood levels, e.g., 0.3953/0.0.9969=39.65%. This data indicates that dietary protein at 100% of RDA is not sufficient to sustain blood 12,13-diHOME. On the other hand, the dogs in the high protein group that were provided with dog food at 177% RDA of protein (even when provided fewer calories than the MERS) experienced a fairly significant increase in the average blood levels of 12,13-diHOME. More specifically, the dogs in the high protein group that were offered the high protein diet exhibited nearly a 2-fold increase in 12,13-diHOME compared to their baseline blood levels, e.g., 2.3756/1.1951=1.99-fold increase.

### Example 5—Analysis of Dog Data

The results from the two high protein studies, namely the study of Examples 1, 2, 4 and 5 and the study of Examples 3 and 6, indicated that, without any physical exercise or other activity that may otherwise increase 12,13-diHOME blood levels, e.g., voluntary cold exposure, etc., the dogs that were fed even a full RDA of dietary protein could only maintain a relatively low blood levels of 12,13-diHOME (0.3953) compared to the baseline blood level when the dogs were fed at 160% of the protein RDA (0.9969), particularly when on a reduced calorie diet based on MERs. See data in Table 6. More specifically, the results from the two studies (feeding higher than 100% MER of Examples 1, 2, and 3 or feeding less than 100% MER in Examples 4, 5 and 6) showed that dogs fed 100% of RDA of dietary protein exhibited reduced blood levels of 12,13-diHOME compared to the baseline blood levels when the dogs were fed at 157 to 160% of the protein RDA, dogs fed 196% of RDA of dietary protein exhibited a slight increase 12,13-diHOME under condition of feeding at 125% of MERs, and dogs fed at 401% of RDA of dietary protein exhibited a much more significant increase in 12,13-diHOME by about six (6) fold over the baseline when the dogs were fed at 157 of the protein RDA. When the dogs were fed less than 100% of their MERs (examples 4,5 and 6), dogs fed 177% RDA of dietary protein increased blood level of 12,13-diHOME by about two (2) fold over the baseline. Those data indicates that high dietary protein can deliver health benefits to the dogs similar to that of physical exercise regardless of total caloric intake.

Thus, by increasing the dietary protein above an estimated 140% of RDA, the blood levels of the 12,13-diHOME could be increased markedly over the baseline, e.g. 2.52 fold increase by providing 160% of RDA protein (Table 6). Increasing RDA protein intake from 160% to 177% increased blood 12,13-diHOME by 1.99-fold. Increasing RDA protein intake from 157% to 401% increased blood 12,13-diHOME by 6.44-fold. Thus, feeding an animal at least about 140% of the RDA of protein can significantly increase the levels of 12,13-diHOME in blood, and feeding the animal at least about 160% of RDA of protein can typically increase the blood levels of 12,13-diHOME in blood by 2.52 folds, thus mimicking some of the health benefits associated with physical exercise. It is also noted that the increased blood levels of 12,13-diHOME were obtained, regardless of whether the animal was overfed (as in Examples 1-3) or underfed (Examples 4-6), indicating the total calories fed to the animal did not prevent the upregulation of the blood 12,13-diHOME by high dietary protein.

### Example 6—Comparative 12,13-diHOME Blood Levels Resulting from Exercise

A study of twelve (12) human subjects, including 6 males and 6 females, evaluated the production of exercise-induced 12,13-diHOME, and the data collected was averaged over the 12 subjects. See Stanford K I, Lynes M D, Takahashi H, Baer L A, Arts P J, May F J, Lehnig A C, Middelbeek R J W, Richard J J, So K, Chen E Y, Gao F, Narain N R, Distefano G, Shettigar V K, Hirshman M F, Ziolo M T, Kiebish M A, Tseng Y H, Coen P M, Goodyear L J. 12,13-diHOME: An Exercise-Induced Lipokine that Increases Skeletal Muscle Fatty Acid Uptake. Cell Metab. 2018 May 1; 27 (5): 1111-1120.e3. doi: 10.1016/j.cmet.2018.03.020. Erratum in: Cell Metab. 2018 Jun. 5; 27(6):1357. PMID: 29719226; PMCID: PMC5935136. Specifically, 12,13-diHOME levels were determined using blood sampling collected pre-exercise, during exercise (at minute 15 of a 45-minute treadmill session running at 75% peak oxygen uptake), post-exercise (immediately upon ceasing exercise), and one (1) hour post-exercise. The data collected from the subject is averaged and approximate values are provided in Table 7, as follows:

TABLE 7
Exercise-induced 12,13-diHOME Blood Levels

| | Blood Levels (pmol/mL Plasma) | | | |
|---|---|---|---|---|
| | | During | | 1 hour |
| | Pre-exercise | Exercise | Post-exercise | post-exercise |
| 12,13-diHOME | 0.75 | 1.15 | 1.45 | 0.6 |

As can be seen in Table 5, 12,13-diHOME blood levels started relatively low with this group of individuals, began to rise early during exercise, peaked immediately following exercise, and then plunged below the pre-exercise levels about an hour after completing the 45-minutes of exercise. This is in contrast to the increased levels of 12,13-diHOME in the blood that can be obtained by a high protein diet. For example, by comparing the data illustrating the benefit of a high protein diet as it relates to 12,13-diHOME blood levels as described in Examples 1-4 related to dogs with the study of the present example showing the 12,13-diHOME blood levels resulting from physical exercise, it is understood that an increase in protein content in the diet can have a much longer lasting effect (the 12,13-diHOME blood levels remained elevated 24 hours after the high protein meal) than physical exercise. It is notable that dogs are known to be one of the best animals when it comes to modeling biological processes and medical treatment in humans, as they are physiologically similar to humans, have roughly the same number of genes as humans, and their genome has been sequenced.

This example (Example 6) illustrates that the 12,13-diHOME blood levels right after physical exercise were about 1.93 times higher than they were just prior to physical exercise. However, an hour later, the 12,13-diHOME blood levels precipitously decreased (or dropped). Conversely, using the dog studies of Examples 1-4 as a model for human benefits, it is understood that a high protein diet, even at about 24 hours post-feeding, 12,13-diHOME blood levels can be maintained at relatively high levels by providing at least about 140% of the RDA of protein, and in some cases, by providing at least about 155% of the RDA of protein can further increase the blood levels of 12,13-diHOME above the baseline blood level. This increase in 12,13-diHOME blood levels appears to be more consistent than that provided by mere physical exercise, even after about 24 hours post-meal.

In the specification, there have been disclosed certain embodiments of the invention. Although specific terms are employed, they are used in a generic and descriptive sense only and not for purposes of limitation. The scope of the invention is set forth in the claims. Many modifications and variations of the invention are possible in light of the above teachings. It is therefore to be understood that within the scope of the appended claims, the invention may be practiced otherwise than as specifically described.

What is claimed is:

1. A method of mimicking health benefits of physical exercise or voluntary cold exposure in an animal, comprising administering to the animal a high protein diet including from about 150% to about 400% of a Recommended Daily Allowance (RDA) of protein for the animal on a daily basis, wherein the high protein diet is sufficient to increase a 12,13-diHOME blood level for an 18-24 hours period per day compared to a baseline blood level without the need for the physical exercise or voluntary cold exposure.

2. The method of claim 1, wherein the high protein diet includes from about 175% to about 400% of the RDA of protein and the 12,13-diHOME blood level is increased by at least 2-fold over the 18-24 hour period compared to the baseline blood level.

3. The method of claim 1, wherein the 12,13-diHOME blood level is higher over the 18-24 hour period compared to the baseline blood level without the animal engaging in physical exercise or voluntary cold exposure.

4. The method of claim 1, wherein the animal is a pet.

5. The method of claim 1, wherein the pet is a dog.

6. The method of claim 5, wherein the RDA of protein for the dog is 18 wt % based on 100% of a maintenance energy requirement for the dog, and wherein the high protein diet includes administering a dog food on a daily basis containing from about 25 wt % to about 75 wt % protein calculated based on the 100% of the maintenance energy requirement for the dog.

7. The method of claim 6, further comprising administering from about 50% to about 95% of the maintenance energy requirement for the dog, wherein the dog food still includes an equivalent of the about 25 wt % to about 75 wt % protein calculated based on the 100% of the maintenance energy requirement.

8. The method of claim 1, wherein the animal is a human.

9. The method of claim 8, wherein administering the high protein diet includes administering from about 1.0 g/kg to about 4 g/kg of the protein daily, and wherein the administering increases the 12,13-diHOME blood level compared to the baseline blood level.

10. The method of claim 8, wherein the human is identified as leading a sedentary lifestyle of less than 30 minutes of exercise per week.

11. The method of claim 8, wherein the human has a disability that diminishes the ability of regular physical exercise.

12. The method of claim 1, wherein the animal is a companion animal that does not experience physical exercise or voluntary cold exposure on more than about one day per week on average.

13. The method of claim 1, wherein after about 3 days on the high protein diet, the 12,13-diHOME blood level is increased compared to a baseline blood level for a full 24 hours per day.

14. The method of claim 1, wherein administering to the animal the high protein diet includes administering the high protein diet on daily basis for a period of time at least 1 week.
